(19) United States
(12) Patent Application Publication
(10) Pub. No.: US 2003/0144800 A1
(43) Pub. Date: Jul. 31, 2003

(54) Methods and system for hazardous material early detection for use with mail and other objects

(75) Inventors: Charles E. Davis, Claremore, OK (US); Juan E. Flores, Owasso, OK (US); Dennis L. Kenbeek, Broken Arrow, OK (US)

Correspondence Address: PERKINS, SMITH & COHEN LLP, ONE BEACON STREET, 30TH FLOOR, BOSTON, MA, 02108, US

(73) Assignee: Lockheed Martin Corporation

(21) Appl. No.: 10/334,504

(22) Filed: Dec. 31, 2002

Related U.S. Application Data
(60) Provisional application No. 60/344,843, filed on Dec. 31, 2001.
(60) Provisional application No. 60/344,845, filed on Dec. 31, 2001.

(51) Int. Cl. G01N 31/00

(52) U.S. Cl. 702/22

(57) ABSTRACT

The present invention provides methods and systems for the application of the analysis of radiation interactions to early detection hazardous material. The method, in a mail processing system, includes the steps of: (a) positioning one or more sensors, a sensor including a radiation source, a detector and the analysis instructions in the computing unit, along the path of a transport system for processing the mail, (b) sensing the presence of a hazardous material in a mail piece, and (c) culling the mail piece, if the presence of hazardous material is detected where culling includes, but not limited to, one or more of the following: diverting to a secure pocket and alerting, removing from the processing stream, alerting and interrupting the processing stream in order to remove an item, diverting the item from the processing stream for further inspection.

### CROSS REFERENCE TO RELATED APPLICATIONS

This application claims priority of U.S. Provisional Applications Nos. 60/344,845 and 60/344,843 filed on Dec. 31, 2001, which are hereby incorporated by reference.

### BACKGROUND OF THE INVENTION

This invention relates generally to the detection of hazardous material, and, more particularly to the application of image processing to early detection of potentially hazardous material associated with mail collection or the collection of other objects.

Recently there has been increased awareness of the potential for large-scale introduction of hazardous materials, that is, either explosives or biological organisms to create chaos or to harm an intended set of victims. One potential delivery method that terrorists or other criminals utilize to deliver such hazardous materials is through the mail or other form of a delivery. In so doing damage, not only is damage incurred by the intended victims, but also to any set of potential victims that may be in a postion of handling such objects as the mail during the delivery or distribution process.

There is currently technology available to law enforcement organizations to detect the presence of both explosive and biological threats. Such test materials generally are sensitive to specific hazardous materials and are utilized when directly put in contact with such hazardous materials. To date, however, there is a lack of early detection of such hazardous material especially in the early phases of mail handling or processing. Systems in place today do not deal with detection prior to entering into the formal distribution process. Thus, all along the distribution process potential nonintended victims are being subjected to hazardous material carried by, for example, letter or package mail.

While complete inspection would be costly, early detection with high accuracy while preventing false negatives, which allows suspected items to be culled from processing stream and be fully inspected, is desirable.

### SUMMARY OF THE INVENTION

The present invention provides methods and systems for the application of the analysis of radiation interactions to early detection hazardous material. Although not limited thereto its primary use may occur in the mail collection system prior to the distribution of such mail or other objects for its intended victims and particularly in the initial stages of the normal flow of processing. Such hazardous material may be in the form of bio-chemical substances, such as anthrax, or explosives. The advantages of the present invention are achieved by the embodiments of the invention described below.

To achieve these and other objectives, there is provided a system and a process, including:

A. exposing the object with a radiation source,

B. detecting the signal from the interaction between the radiation source and the object,

C. analyzing the detected signal applying an early warning criterion,

D. if the early warning criterion indicates that the object contains potentially hazardous materials, cull the object and set it aside for full inspection.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 depicts a flow chart of an embodiment of the method of this invention;

FIG. 2a depicts a schematic block diagram of one embodiment of this invention;

FIG. 2b depicts a schematic graphical representation of another embodiment of this invention;

FIG. 2c depicts a schematic graphical representation of yet another embodiment of this invention;

FIG. 3 depicts a schematic block diagram of still another embodiment of this invention;

FIG. 4 depicts a schematic block diagram of a further embodiment of this invention;

FIG. 5 illustrates the contents of an embodiment of a database that provides data to be compared against results of interactions.

### DETAILED DESCRIPTION OF THE EMBODIMENTS

Methods and systems for the application of the analysis of radiation interactions to early detection of hazardous material are disclosed hereinbelow.

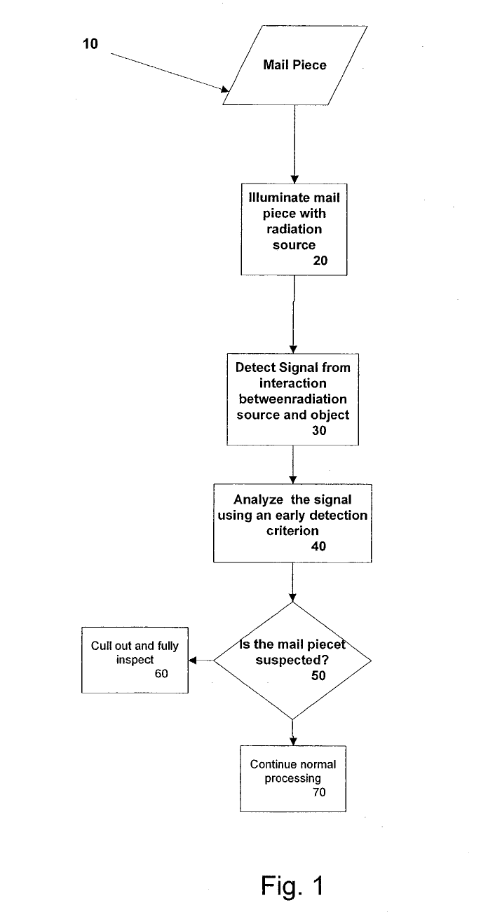

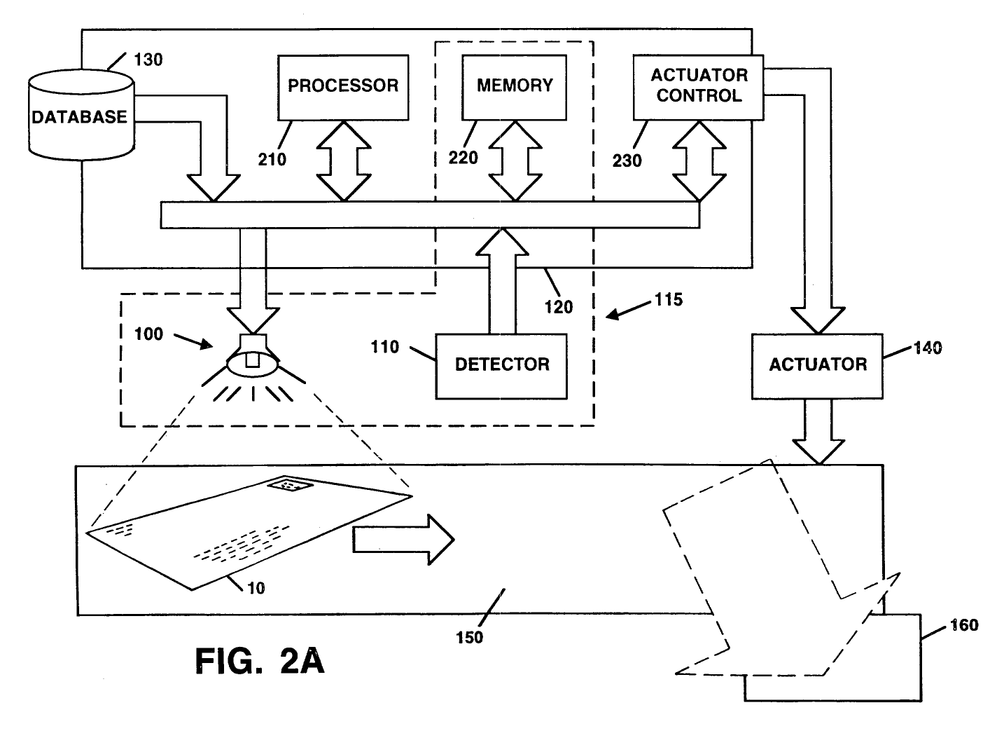

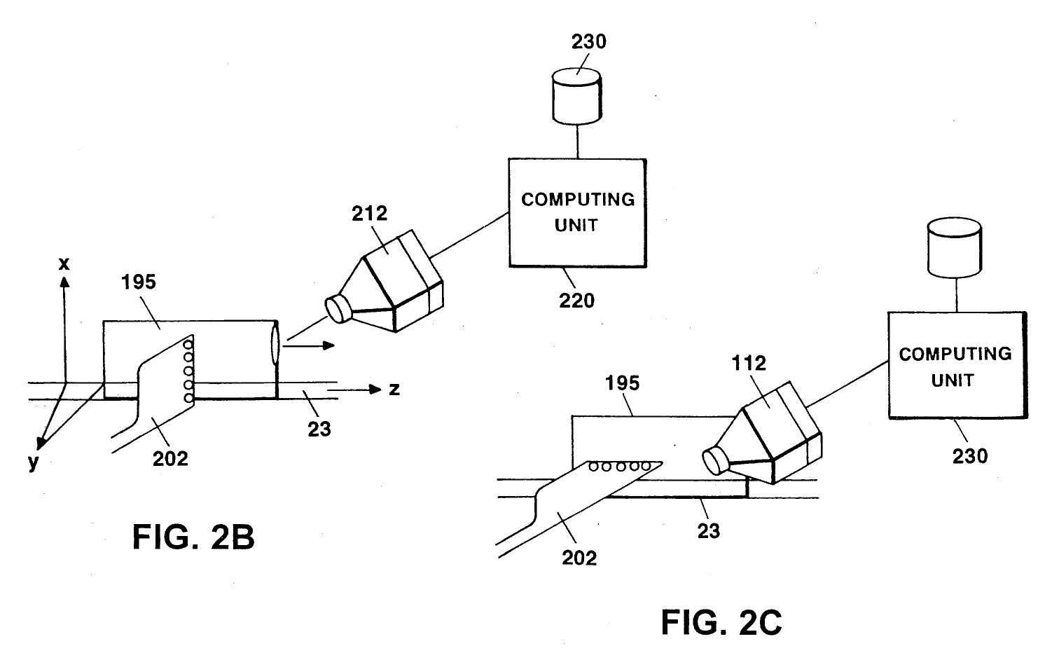

Referring to FIGS. 1 and 2a, a mail piece 10 is illuminated by (exposed to) a radiation source 100 (step 20, FIG. 1). The signal generated by the interaction between the mail piece 10 and radiation from the radiation source 100 is detected by detector 110 (step 30, FIG. 1). The signal is analyzed using a computing unit 120 executing computer readable code embodied in memory 120 and compared to data from a database 135 (step 40, FIG. 1) and an early detection criterion is applied. If the early detection criterion indicates that the mail piece 10 could contain potentially hazardous material (step 50, FIG. 1), the mail piece 10 is culled out and diverted by actuator 140 to a location where the mail piece 10 is fully inspected (step 60, FIG. 1). Culling a mail piece (item), as used herein, includes, but not limited to, diverting to a secure pocket and alerting others to the presence of hazardous material, removing from the processing stream, alerting others by sounding an alarm, alerting others and/or interrupting the processing stream in order to remove an item, diverting the item from the processing stream for further inspection—for diverting and alerting. If the early detection criterion does not indicate that the mail piece 10 could contain potentially hazardous material, normal processing of the mail piece resumes (step 70, FIG. 1).

The method, as used in a mail processing system, can include, but is not limited to, the steps of: (a) positioning one or more sensors (a sensor 115 includes a radiation source 100, a detector 110 and the analysis instructions in the computing unit 120) along a transport path and associated with components of a transport system for processing the mail (150, FIG. 2a), (b) sensing the presence of a hazardous material (also referred to as a harmful agent) in a mail piece (steps 20, 30, 40, 50 of FIG. 1), and (c) culling the mail piece (item), if the presence of hazardous material is detected (step 60) where culling includes, but not limited to, one or more of the following procedures: diverting the mail piece to a secure pocket and alerting others to the presence of hazardous materials, removing the mail piece from the processing stream, alerting others and interrupting the processing stream in order to remove an item, diverting the item from the processing stream for further inspection. In some circumstances, the term culling can also be include the indication of an alarm condition and responding to that condition.

In one embodiment of FIG. 2a, the detector 110 and sources of radiation 100 are selected such that speed of the conveyor belt remains the same as in normal operation. In this embodiment, some of the analysis methods are not utilized since the utilization of such methods would require reducing the speed of transport of the mail pieces (the speed of the conveyor belt). However, in some transport systems, the transport path is long enough, and/or physical buffers exist, and detection or analysis can occur without modifying the speed of the transport system.

In one embodiment capable of operating at the normal transport speed, shown in FIG. 2b, the radiation source 100 of FIG. 2a is a high brightness visible light source 105, a “stripe optical source” in one embodiment, and the detector 110 of FIG. 2a is a multi-element detector 112, such as, but not limited to, a high speed video camera or a highly sensitive multi-pixel area optical detector, such as a CCD. (A stripe source can be obtained by coupling an optical source to an optical fiber bundle and then changing the bundle configuration into a linear configuration.) The multi-element detector 112 is offset, along the direction of transport, from the radiation source 105 and on the opposite side of the mail piece 10, which is being transported by “pinch belt” transport 212. (The “pinch belt” transport 212 is an embodiment of conveyor system 150 of FIG. 2a.) The output of the detector 112 is provided to computing unit 120. The detector output is indicative of the transmission through the mail piece 10. FIG. 2c depicts another orientation of the high brightness visible light source 105 with respect to the mail piece 10.

“Clumps” or mounds of material will appear as reductions in transmission (or in a shadow). Since the “clumps” are small, the shadow area will be small. This relationship translates into the requirements for the detector. (A preferred detector would be a sensitive detector such as a CCD detector used for astronomy but also including high resolution.) Similarly, isolated particles translate into isolated reductions in transmission and the shadow area will be smaller than that of “clumps”. “Clumps” and particles have specific shadow characteristics. For example, “clumps” have a curved shadow exhibiting a wider gray scale range transition to the background noise level (background noise as used herein refers to the signal in the absence of any other detectable features). Other detectable features, such as lettering, folds, and markings exhibit a sharper transition in gray scale to the background noise level. The brightness of the source is selected such that the difference between “clumps” or particles and other detectable features can be discerned. The output of the detector is provided to computing unit 120 where it is analyzed utilizing an algorithm residing in memory 220. In one embodiment, the algorithm utilizes a conventional algorithm to obtain grayscale values and obtains “shadow” characteristics (gray scale gradients) around reductions in transmission that are potentially “clumps” or particles. The algorithm distinguishes between ordered reductions in transmission due to addresses, bar codes and the reductions in transmission due “clumps” and particles utilizing the specific shadow characteristics of the “clumps” and particles. The results of the analysis are compared to thresholds stored in memory 220 (FIG. 2a) or database 130 (in this embodiment memory 220 could perform the function of database 130). An early warning criterion is applied by comparing the results of the analysis to the thresholds. If the results of the analysis exceed the thresholds, the early warning criterion indicates that the mail piece 10 is suspicious (indicates the presence of a potentially hazardous material). However, it should be noted that the above described method does not discriminate with respect to the nature of the material comprised in the “clumps” and particles. Any clump forming or particulate material having the same or similar shadow characteristic will be detected.

In another embodiment, in which the detector and sources of radiation are selected such that speed of the conveyor belt remains the same as in normal operation, the source of radiation 100 is an illumination source in the visible range of wavelengths. The mail piece 10 is placed on conveyor belt 150 and moves in the direction of the arrow. It should be noted that the means for transporting the mail piece 10, the conveyor belt 150 for example, can also include means for determining the speed of the belt and position along the belt (an encoder, for example). The determination of the speed and position allows a timing signal to be generated so that illumination can be synchronized with the position of the mail piece 10. The source of radiation 100 and the detector 110 include optical elements designed to enable the generation of a digital image of the mail piece 10. In one embodiment, the illumination source 100 includes an unsymmetrical elliptical reflector as described in U.S. Pat. No. 5,770,841. In another embodiment, the illumination source 100 can include other optical elements so that when combined with the optical elements in the detector a desired image of the mail piece 10 is formed. Detector 110 could be, for example, a CCD detector or a CMOS detector. A digital image of the mail piece 10 is obtained from the detector 110. It should be noted that the digital image could be obtained as an entire image or as a collection of line images depending on the structure of the detector used.

The digital image is then processed and the location and content of blocks containing relevant data (addresses, ZIP codes, etc.) identified (see for example U.S. Pat. No. 6,289,109). The algorithm that identifies the location containing relevant data can be, for example, the correlation and threshold algorithm disclosed in U.S. Pat. No. 5,386,482 or the algorithm for detecting Areas of Interest (AOI) found in M. Wolf et al., “Fast Address Block Location in Handwritten and Printed Mail-piece Images”, Proc. Of the Fourth Intl. Conf. on Document Analysis and Recognition, vol. 2, pp. 753-757, Aug. 18-20, 1997, or the segmentation methods defined in P. W. Palumbo et al., “Postal Address Block Location in Real time”, Computer, Vol. 25, No. 7, pp. 34-42, July 1992, or the algorithm for generating address block candidates described in U.S. Pat. No. 6,014,450. Once the block is identified. The address blocks are then classified as such (see for example, U.S. Pat. No. 6,014,450).

If the data in the blocks of interest is printed data, optical character recognition (OCR) techniques can be used to obtain the information in the blocks of interest. The identifying of the address blocks and the OCR are performed, in one embodiment, by processor 210 following instructions embodied in memory 220. The information obtained from the blocks of interest—addresses, ZIP codes, structure of the blocks, missing return address blocks, etc.—is compared against the database 130. (The information obtained from the blocks of interest could have been obtained in the normal processing of the mail and the radiation source and detector used could be those used for the electronic reading of addresses—OCR.) Database 130 contains known factors that would render a mail piece suspicious (indicate the presence of potentially hazardous material). Based on those factors—known suspicious names and addresses, known targeted addressees, known suspicious ZIP codes, structure of the blocks, missing return address blocks—a score or probability of suspiciousness is generated. An early warning criterion is applied by comparing the score to a threshold. If that score or probability exceeds the threshold, the early warning criterion indicates that the mail piece 10 contains potentially hazardous materials.

In the embodiments described herein below, the speed of the conveyor belt could be slower than that utilized during normal operation. In one embodiment in which the speed of the conveyor belt could be slower than that utilized during normal operation or in which a longer transport path and/or physical buffers are required, if the data in the blocks of interest is hand written, the data can be analyzed and some information about the author determined (see for example U.S. Pat. No. 6,160,914, and “Recent advances in off line handwriting recognition at CEDAR”, S. N. Srihari, SUNY-Buffalo, http://www.cedar.buffalo.edu/Publications/TechReps/OLHWR/offli nehwr.html). In addition to the information obtained from the blocks of interest—addresses, ZIP codes, structure of the blocks, missing return address blocks, etc.—, the database 130, in this embodiment contains information relating to the structure of the handwriting—loopiness, openness, self correlation as used by Srihari or coordinate information and writing pressure information as used in U.S. Pat. No. 6,160,914. As in the previous embodiment, based on those factors, a score or probability of suspiciousness is generated. An early warning criterion is applied by comparing the score or probability to a threshold. If that score or probability exceeds the threshold, the early warning criterion indicates that the mail piece 10 contains potentially hazardous materials.

In still another embodiment, the output of the detector 110 is analyzed in order to reconstruct a three dimensional image from the two dimensional image produced by the detector 110. The placement of the detector 110 with respect to the source 100 and the mail piece 10 is chosen for optimum image conditions. Various mathematical techniques can be used to reconstruct the three dimensional image from the two dimensional image produced by the detector 110 (see for example the references in “Introductory Literature Review-Surface Reconstruction from Three Dimensional Range Data”, A. Myers, http://homepages.picknowl.com.au/myers/surface/SummaryLiteratu reReview.htm#sdendnote33anc, and the method presented in A. Hertzmann, “Automatic Scene Reconstruction from Images”, NYU Computer Science Technical Report TR1999-783, New York University, Apr. 12, 1999). The three dimensional reconstructed image of the mail piece 10 is further analyzed in order to determine “mounds” or protrusions and is compared to the data in the database 130. Comparing to known suspicious “mounds” or protrusions stored in the database 130, a score or probability of suspiciousness is generated.

In yet another embodiment, the source of radiation 100 is a source of coherent radiation. The wavelength of the coherent radiation produced by source 100 is selected based on availability of sources and detectors. (Laser diodes are available from the infrared to the visible and CCD and CMOS detectors are available over those frequencies. Other laser systems are available over a wider range of wavelengths. For an overview of laser systems and detectors, see, for example, J. T. Verdeyen, Laser Electronics, 2nd edition, ISBN 0-13-523630-4, Ch. 10 and 16, 1989.) In one embodiment utilizing a source of coherent radiation, the scattered and reflected signal from the mail piece 10 is imaged onto the detector 110. Roughness or irregularities (such as those caused by particles) on the surface of the mail piece 10 can result in the phenomenon known as “speckle”. “Speckle” is best described by the statistical properties of the scattered radiation such as the second order statistics (the correlation and auto-correlation). Since the spectral intensities of the second order statistics depend on the height distribution of the roughness or irregularities, the spectral intensities of the second order statistics can be used to determine the properties of the surface irregularities (see, for example, N. George, Tutorial on Optical Systems, Institute of Optics, University of Rochester, 1990, pp. A1-A47). The measured second order statistics of the scattered radiation (or the spectral intensities of the second order statistics) are compared to known second order statistics of the scattered radiation (or the spectral intensities of the second order statistics) from suspicious conditions, which are stored in database 130. A score or probability of suspiciousness is then generated.

In another embodiment utilizing a source of coherent radiation, the source of coherent radiation 100 is partially absorbed by components of the mail piece 10. The absorption of the coherent radiation induces emission of radiation by components of the mail piece 10. The detector 110, in this embodiment, includes means for detecting the emitted radiation in a number of wavelength bands. Examples of such means (also referred to as wavelength separating means) are tunable filters, such as Liquid Crystal Tunable Filters (LCTF) or Acousto-optic Tunable Filters (AOTF) or a holographic grating or a prism or a polychromator, placed between the emitting mail piece 10 and the photo-detecting component of detector 110. Collecting optics could be used between the wavelength separating means and the emitting surface. The photo-detecting component can be a photodiode array, a CCD or CMOS detector. An emission spectrum is generated from the detected radiation emitted into a number of wavelength bands. The emission spectrum is compared to known emission spectra for suspicious substances, such as biological agents, contained in database 130. A score or probability of suspiciousness is then generated by processor 210.

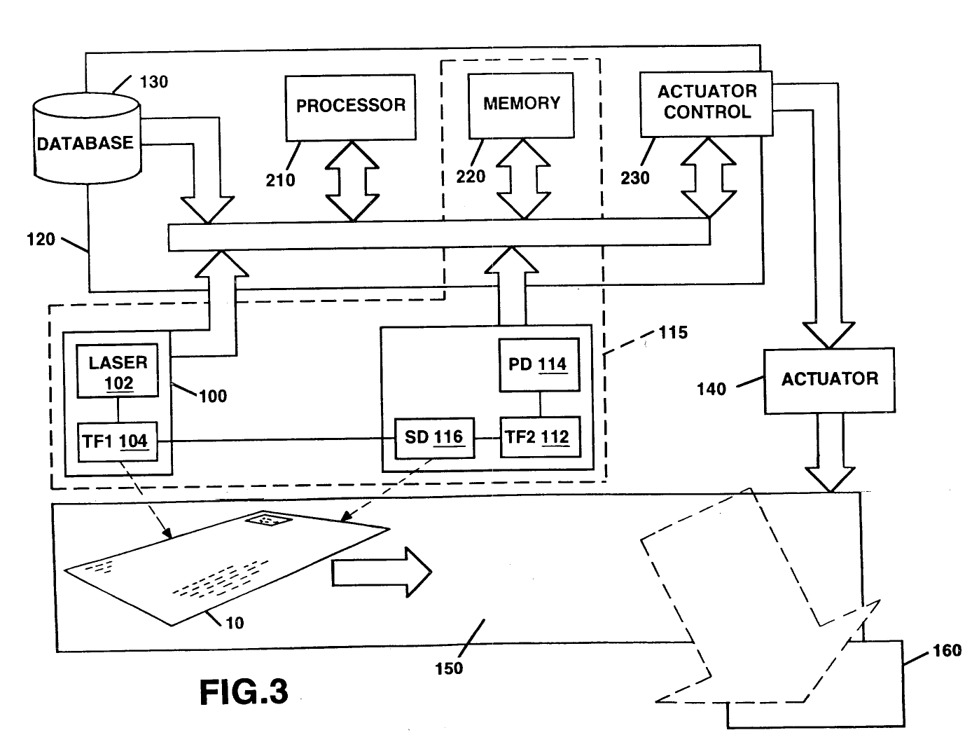

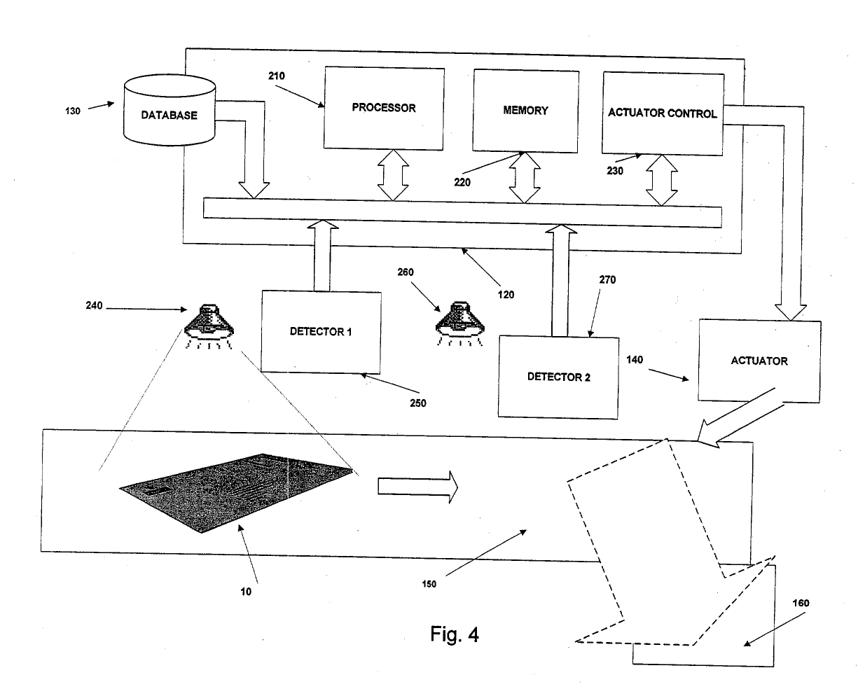

The wavelength of the laser in the above described embodiment would be selected to excite a portion of the emission spectrum having a relatively large amplitude. In a different embodiment, following the teachings of U.S. Pat. No. 5,938,617, a wider portion of the spectrum is imaged. Referring to FIG. 3, radiation source 100 includes a laser 102 and means 104 for changing or selecting the wavelength of the radiation source 100, such as a tunable filter, enabling the scanning of the radiation source wavelength. Delivery optics (which could include fiber optics) can be included in source 100. Detector 110 includes means 112 for scanning the emitted radiation wavelength, such as another tunable filter, a photodetector 114, and a synchronizing device 116 for synchronizing the scanning of the emitted radiation wavelength with the scanning of the coherent radiation source wavelength, ensuring that the scanned source radiation wavelength and the detected radiation wavelength are maintained at a constant interval. In one embodiment, a multi-dye module (MDM) constitutes means 104. In another embodiment (not shown), the laser 102 and the means 104 of FIG. 3 can be replaced by a solid state scanning laser (e.g., titanium sapphire laser) or other scanning laser systems equipped with optical parametric oscillator (OPO) devices. The means 112 for scanning the emitted radiation wavelength can, in one embodiment, include a variable monochromator and the photodetector 114 can, in one embodiment, include a photomultiplier. When the laser 102 is pulsed and the means 104 include a multi-dye module, means 112 for scanning the emitted radiation wavelength can include a polychromator and photodetector 114 can include a multi-channel detector such as a CCD or photodiode array.

In yet another embodiment (also not shown), laser 102 of FIG. 3 may be replaced by a broadband continuum light source. Means 104 for changing or selecting the wavelength of the radiation source 100 and means 112 for scanning the emitted radiation wavelength may include acousto-optic tunable filters (AOTF). The AOTFs can be driven by RF sources controlled by system 120 thereby achieving the synchronous scanning of both AOTFs. Such an arrangement constitutes a synchronizing device 116. The AOTFs can be replaced by liquid crystal tunable filters (LCTF) or optical Fabry-Perot tunable filters (FPTF). (Further details of these embodiments can be found in U.S. Pat. No. 5,938,617.)

In the above embodiments of the system of FIG. 3, an emission spectrum is generated from the detected radiation emitted into the scanned detected wavelengths. The emission spectrum is compared to known emission spectra for suspicious substances, such as biological agents, contained in database 130. A score or probability of suspiciousness is, then, generated by processor 210.

In all the preceding embodiments, if the score or probability exceeds the threshold, the early warning criterion indicates that the mail piece 10 contains potentially hazardous materials. If the early detection criterion indicates that the mail piece 10 is suspected of containing potentially hazardous material, a control signal is issued from computing unit 120 to actuator 140 through actuator controls 230. The actuator 140 then diverts the mail piece 10 into alternate path 160. Then, the mail piece 10 can be further analyzed.

While the above embodiments relate to known sign of suspicious originators of the mail piece or the detection of biological hazards, other embodiments of the system of this invention, which are capable of the detection of explosives, are also possible. In one embodiment the radiation source 100 is a scanning X-ray source of the appropriate spectrum so that the back scattered radiation is typical of low atomic number (low Z) elements such as found in explosives. Since X-rays are ionizing radiation, shielding could be necessary. The detector 110 is an X-ray detector such as photo-multiplier tube (PMT). The output of the detector is analyzed and the analysis results compared to a threshold, which is stored in database 130. (One example of such an analysis is given in U.S. Pat. No. 5,179,581, where the histogram of pixel intensities is used.) Based on the comparison and other stored information, such as a past performance or record of false positives, a score or probability of suspiciousness is generated by processor 210. “Culling” after detection of explosives, in one embodiment, can include alerting and interrupting the processing stream in order to remove an item.

In another embodiment of the system of this invention, also capable of the detection of explosives, the radiation source 100 is a source of low intensity radio waves comprising a train of pulses of predetermined pulse width and radio wave frequency. The radio wave frequency is selected to be near a Nuclear Quadrupole Resonance (NQR) of a material of interest (¹⁴N for example, for RDX based explosives) and the pulse width is determined by the spin relaxation time. Detector 110 includes a receiving antenna or coil and circuits to receive and process the NQR signal (see, for example, U.S. Pat. No. 6,194,898). Processing of the signal can take place using processor 210 or a dedicated processor (considered part of the detector). The result of the processing is a spectrum, intensity as a function of frequency. The output, at predetermined frequencies, is compared to a threshold, which is stored in database 130. Based on the comparison, a score or probability of suspiciousness is generated by processor 210.

In yet another embodiment of the system of this invention, also capable of the detection of explosives, the radiation source 100 is a source or an array of sources of thermal neutrons. Detector 100 is a gamma ray detector or an array of gamma ray detectors. (When nitrogen is subjected to thermal neutrons, gamma rays of predetermined frequencies are emitted.) The output of the gamma Ray detectors at the predetermined frequencies (or equivalently energies) is compared to the known response for nitrogen, which is stored in database 130. If the output at the known suspicious frequencies exceeds a threshold, a score or probability of suspiciousness is generated by processor 210. Placement of the detectors can be important in these embodiment since many common items contain nitrogen and false detection is possible (see for example European Patent Application publication number 0413527A2). Also, since many neutron sources are continuous sources and gamma Rays are ionizing radiation, shielding will be necessary. The above considerations may render this embodiment not as attractive as the previous embodiments.

In other possible embodiments of the system of this invention, the radiation source 100 is either a source of ultrasound radiation or a source of X rays. The detector of 110 is either an array of ultrasound detectors or an X-ray detector (such as a photo multiplier tube). For ultrasound, the interaction of interest is scattering and transmission of ultrasound from the mail piece 10. For X-rays, the interaction of interest is the absorption of X-rays by the mail piece 10. In either one of these embodiments, the structure (a two dimensional projection or a three dimensional reconstruction in an embodiment utilizing computed tom0graphy (CT)) of objects located inside of the mail piece 10 can be determined by the analysis of the detector output. The structure resulting from the analysis can be compared to the data in the database 130, structure of known suspicious objects. If the detected structure is within a given threshold of the known suspicious structure, a score or probability of suspiciousness is generated by processor 210.

In a further embodiment of the system of this invention, for shown in FIG. 4, two or more radiation sources 240, 260 are utilized. Each radiation source is different from any other of the radiation sources. Utilizing more than one radiation source enables different embodiments of the step (step 40, FIG. 1) of applying an early detection criterion. The signal produced by the interaction of source 240 and mail piece 10 is analyzed using the computing unit 210 following computer readable code embodied in memory 220 and the results of the analysis are compared to data from the database 130. A first preliminary early warning criterion is applied to that comparison. The signal produced by the interaction of source 260 and mail piece 10 is also analyzed using the computing unit 210 following computer readable code embodied in memory 220 and the results of the analysis are compared to data from the database 130. A second preliminary early warning criterion is applied to the results of the comparison of the analysis of results of the interaction between source 260 and mail piece 10. In one embodiment, a mail piece 10 is considered suspicious (considered to contain potentially hazardous materials) when the two preliminary early warning criteria indicate that mail piece contains potentially hazardous material. In another embodiment, a mail piece 10 is considered suspicious when any of the two preliminary early warning criteria indicate that mail piece is suspicious (contains potentially hazardous materials).

The system can be described as including (a) components of a transport system for processing the mail (150, FIGS. 2, 3, 4), (b) one or more hazardous material sensors, a sensor including a radiation source 240, 260, a detector 250, 270 and the analysis instructions in the computing unit 120, along the path and associated with components of a transport system for processing the mail (150, FIGS. 2, 3, 4), (c) at least one processor 210 receiving information from the hazardous material sensors, and (d) a sub-system (230, 140) capable of culling the mail piece (item), if the presence of hazardous material is detected where culling includes, but not limited to, one or more of the following procedures: diverting the mail piece to a secure pocket and alerting others to the presence of hazardous material, removing the mail piece from the processing stream, alerting and interrupting the processing stream in order to remove an item, diverting the item from the processing stream for further inspection. In some circumstances, the term culling can also include the indication of an alarm condition and responding to that condition.

In yet another embodiment, the analysis results for the signal produced by the interaction of several sources and the mail piece 10, for example, the results for source 260 and mail piece 10 and the results for the signal produced by the interaction of source 240 and mail piece 10 (FIG. 4), are combined to produce a more accurate result. Each combination of source and mail piece, if analyzed separately, will produce a true positive early warning criterion for a certain percentage of true suspicious situations and a certain percentage of false positive results for non suspicions situations. The use of two early warning criteria in tandem will reduce the percentage of true suspicious situations due to the rules for combining probabilities. Techniques of sensor fusion can be used to combine two or more analysis results to arrive at a lower percentage of true suspicious situations missed. (See, for example, D. L. Hall and J. Llinas, An “Introduction to Multi-sensor Data Fusion”, Proc. IEEE, Vol. 85, No. 1, pp. 6-23, 1997; R. Viswanathan and P. K. Varshney, “Distributed Detection with Multiple Sensors: Part I-Fundamentals”, Proc. IEEE, Vol. 85, No. 1, pp 54-63, 1997; R. S. Blum, S. A. Kassam, H. V. Poor, “Distributed Detection with Multiple Sensors: Part II-Advanced Topics”, Proc. IEEE, Vol. 85, No. 1, pp. 64-79, 1997.)

In some embodiments data fusion techniques include design of an optimum detector. Optimum detector design criteria include, but are not limited to, minimizing the average probability of error (Bayesian techniques), minimizing the maximum of the false alarm and miss probabilities (minimax detection), and minimizing the miss probability with an upper bound on the false alarm probability (Neyman Pearson detection). In other embodiments, the analysis can minimize the percentage of false positive results and ameliorate the economic impact of further testing or neutralizing mail pieces exhibiting false positive results.

If the mail piece 10 is suspected of containing potentially hazardous material, a control signal is issued from computing unit 220 to actuator 240 through actuator controls 230. The actuator 240 then diverts the mail piece 10 into alternate path 160 or the mail piece 10 can be otherwise “culled”. Then, the mail piece 10 can be further analyzed.

Radiation sources 240 and 260 can be, for, example, in one embodiment, any two distinct radiation sources from those described above—a source of radiation in the visible range of wavelengths, a source of coherent radiation, a continuum light source, a source of X-rays including sources for CT, a source of low intensity radio waves such as, but not limited to, sources for NQR, a source of ultrasound radiation, and a source of neutrons.

In FIGS. 2-4, which depict block diagrams of Embodiments of this invention, a data storage device 130 is shown connected to a system 120. The data storage device 130 contains a database 130 which provides the data utilized to compare with the analysis of the interaction results provided by the processor 210. Data storage device 130 is shown in FIGS. 2-4 as being connected to system 120. It should be noted that data storage device 130 could be physically the same as memory 120 (or 220). It should-also be noted that storage device 130 could be remotely located and in communication with system 120.

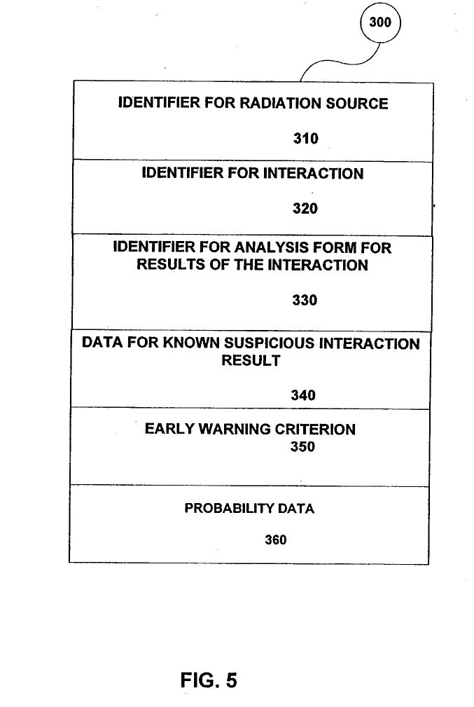

The database 130, depicted in FIG. 5, includes a number of instantiations of a data structure, one instantiation of data structure 300 for every radiation source/interaction pair, where each instantiation of data structure 300, in one embodiment, includes an identifier for the radiation source 310, an identifier for the interaction 320, an identifier for an analysis form for the result of the interaction 330, data for known suspicious interaction results 340, an early warning criterion 350 corresponding to the data 340, and, probability data 360 for the occurrence of a correct identification of each type of hazardous material. Data structure 300 can further include, in one embodiment, probability data for the occurrence of a false alarm condition 370 for each type of hazardous material and probability of missed detection 380 for each type of hazardous material. The probability data is utilized in data fusion algorithms that minimize a measure of the probability of error.

Table 1 below contains a description of items found in or identified by an embodiment of the database 130 and instantiations of data structure 300 and their utilization in applying an early detection criterion.

TABLE 1

| | | | Data that | |
|---|---|---|---|---|
| | | | indicates | |
| | | | presence of | |
| | | | potentially | Early |
| Radiation | | Analysis | hazardous | Warning |
| Source | Interaction | Form | materials | Criterion |
| Visible or | Reflection | location and | known | Score based |
| IR | | content of | suspicious | on |
| | | blocks | addresses, | closeness |
| | | containing | known | to |
| | | relevant | suspicious | Suspicious |
| | | data | ZIP codes, | data |
| | | (addresses, | structure of | |
| | | ZIP codes, | the blocks, | |
| | | etc.) | missing | |
| | | | return | |
| | | | address | |
| | | | blocks | |
| Visible or | Reflection | location and | In addition | Score based |
| IR | | content of | to the | on |
| | | blocks | above, | similarity |
| | | containing | information | with |
| | | relevant | relating to | Suspicious |
| | | data | the | data |
| | | (addresses, | structure of | |
| | | ZIP codes, | the | |
| | | etc.) and | handwriting—loopiness, | |
| | | hand written | openness, | |
| | | data | self | |
| | | | correlation | |
| | | | or | |
| | | | coordinate | |
| | | | information | |
| | | | and writing | |
| | | | pressure | |
| | | | information | |
| Visible or | Reflection | Reconstruction | Known | Score based |
| IR | | of a | suspicious | on |
| | | three | “mounds” or | similarity |
| | | dimensional | protrusions | with |
| | | image from | | Suspicious |
| | | the two | | data |
| | | dimensional | | |
| | | image | | |
| | | produced by | | |
| | | the detector | | |
| source of | absorption | emission | known | Score based |
| coherent | of the | spectrum for | emission | on |
| radiation | coherent | the detected | spectra for | similarity |
| | radiation | emitted | suspicious | with |
| | induces | radiation | substances | Suspicious |
| | emission of | | | data (at |
| | radiation by | | | peak, |
| | components | | | observed |
| | of the mail | | | spectrum |
| | piece | | | within |
| | | | | Threshold |
| | | | | of known |
| | | | | spectrum) |
| (source of | absorption | emission | known | Score based |
| coherent | of the | spectrum, | emission | on |
| radiation | coherent | synchronizing | spectra for | similarity |
| or | radiation | the | suspicious | with |
| broadband | induces | scanning of | substances | Suspicious |
| continuum | emission of | the emitted | | data or |
| light | radiation by | radiation | | threshold |
| source) | components | wavelength | | for |
| and means | of the mail | with the | | differences |
| 104 for | piece | scanning of | | at |
| changing | | the coherent | | suspicious |
| or | | radiation | | spectrum |
| selecting | | source | | peaks |
| the | | wavelength | | |
| wavelength | | | | |
| of the | | | | |
| radiation | | | | |
| source | | | | |
| scanning | X-ray | histogram of | histogram | departure |
| X-ray | detector | pixel | of pixel | from |
| source | such as | intensities | intensities | “normal” |
| | photo- | produced by | produced by | histogram |
| | multiplier | back | low atomic | above a |
| | tube (PMT) | scattered | number (low | given |
| | | radiation | Z) elements | Threshold |
| | | | such as | |
| | | | found in | |
| | | | explosives | |
| source of | Excite | a spectrum, | known NQR | threshold |
| low | Nuclear | intensity as | spectra for | for |
| intensity | Quadrupole | a function | suspicious | differences |
| radio | Resonance | of frequency | substances | at |
| waves—a | (NQR) | | | suspicious |
| train of | | | | spectrum |
| pulses of | | | | peaks |
| predetermined | | | | |
| pulse | | | | |
| width and | | | | |
| radio wave | | | | |
| frequency | | | | |
| a source | Emission of | Detected | known | If output |
| or an | gamma rays | emission at | response | at the |
| array of | of | the | for | known |
| sources of | predetermined | predetermined | nitrogen | suspicious |
| thermal | frequencies | frequencies | | frequencies |
| neutrons | | | | exceeds a |
| | | | | threshold, |
| | | | | a score is |
| | | | | generated |
| a source | absorption | structure of | structure | If the |
| of X rays | of X-rays by | objects | of known | detected |
| (including | the mail | located | suspicious | structure |
| extended | piece | inside of | objects | is within a |
| sources | | the mail | | given |
| for | | piece | | threshold |
| computed | | | | of the |
| tomography) | | | | known |
| | | | | suspicious |
| | | | | structure, |
| | | | | a score is |
| | | | | generated |
| A high | Formation of | Determination | Known | Score based |
| brightness | shadows | of the | shadow | on |
| light | (reduction | shadow or | characteristics | similarity |
| source | in | transmission | for | to Known |
| | transmission) | characteristics | “clumps” | shadow |
| | | | and | characteristics |
| | | | particles | for |
| | | | | “clumps” |
| | | | | and |
| | | | | particles |
| a source | scattering | structure of | structure | If the |
| of | and | objects | of known | detected |
| ultrasound | transmission | located | suspicious | structure |
| radiation | of | inside of | objects | is within a |
| | ultrasound | the mail | | given |
| | from the | piece | | threshold |
| | mail piece | | | of the |
| | | | | known |
| | | | | suspicious |
| | | | | structure, |
| | | | | a score is |
| | | | | generated |

It should be apparent that the process described above can take place in an enclosed or contained section of a system for transporting the objects 10. If the process takes place in an enclosed volume of space, the ambient air contained in that enclosed volume of space can be properly filtered for further protection and operational safety.

The embodiments described above have been described with respect to a mail piece. “Mail Piece” as used in this invention refers to any addressed object in a package or mail delivery system or any item being delivered by means of a mass distribution system.

Steps 40 and 50 of the method of FIG. 1 are shown, in FIGS. 2-4, as implemented in computer readable code embodied in memory 230 and executed by processor 210. However, it should be noted that, in general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized that this invention is also capable of a wide variety of further and other embodiments all within the spirit and scope of this invention.

What is claimed is:

1. A method, for the detection of potentially hazardous materials in mail pieces, comprising the steps of:
exposing one mail piece from a plurality of mail pieces with at least one radiation source;
detecting a signal arising from an interaction between said at least one radiation source and said one mail piece from the plurality of mail pieces, said detection constituting at least one detected signal;
analyzing said at least one detected signal, said analysis producing at least one result;
comparing said at least one analysis result to data from a database;
applying an early warning criterion to said comparison;
if said early warning criterion indicates that said one mail piece from the plurality of mail pieces contains potentially hazardous materials, performing the step of:
culling said one mail piece.

2. The method of claim 1 wherein the step of exposing one mail piece with at least one radiation source further comprises the step of exposing said one mail piece with a source of radiation in the visible range of wavelengths; and,
wherein the step of detecting a signal arising from an interaction further comprises detecting a signal arising from scattering and reflection of said radiation from said one mail piece.

3. The method of claim 2 wherein the step of detecting a signal further comprises the steps of:
directing said reflected and scattered radiation to a detector;
generating at least one signal from said detector.

4. The method of claim 3 wherein the step of analyzing the detected signal further comprises analyzing handwriting on said one mail piece and the step of comparing the analysis comprises comparing said handwriting to a known database.

5. The method of claim 3 wherein the step of analyzing the detected signal further comprises determining protrusions on said one mail piece and the step of comparing the analysis comprises comparing to a database of known suspicious protrusions.

6. The method of claim 3 wherein the step of analyzing the detected signal further comprises the steps of:
determining locations for information on said one mail piece;
identifying and reading said information;
and, wherein the step of comparing the analysis comprises comparing said locations for information and said information to a database of known suspicious characteristics.

7. The method of claim 1 wherein the step of exposing one mail piece with at least one radiation source further comprises the step of exposing said one mail piece with a source of coherent radiation.

8. The method of claim 7 wherein the step of analyzing the detected signal further comprises analyzing scattering and reflection of said radiation from said one mail piece; and, wherein the step of detecting a signal further comprises the steps of:
directing said reflected and scattered radiation to a detector;
generating at least one signal from said detector.

9. The method of claim 8 wherein
the step of analyzing the detected signal further comprises obtaining statistical characteristics of said interaction from said at least one signal;
and, the step of applying an early warning criterion comprises comparing said statistical characteristics to a known database.

10. The method of claim 7 wherein the step of analyzing the detected signal further comprises analyzing absorption of the coherent radiation and generation of emitted radiation;
wherein the step of detecting a signal further comprises the step of detecting the emitted radiation in a plurality of bands of wavelength;
wherein the step of analyzing the detected signal further comprises the step of generating a spectrum of emitted radiation and,
wherein the step of comparing the analysis comprises comparing said generated spectrum to a database of known spectra of potentially hazardous materials.

11. The method of claim 10 wherein the source of coherent radiation further comprises means for scanning the coherent radiation source wavelength; and
wherein the step of detecting a signal further comprises the step of scanning the emitted radiation wavelength, said scanning of the emitted radiation wavelength occurring synchronously with the scanning of the coherent radiation source wavelength.

12. The method of claim 1 wherein the step of exposing one mail piece with at least one radiation source further comprises the step of exposing said one mail piece with a broadband continuum light source and utilizing means for scanning the radiation source wavelength;
wherein the step of detecting a signal arising from an interaction further comprises detecting a signal arising from absorption of said radiation and generation of emitted radiation; and,
detecting the emitted radiation in a plurality of bands of wavelength; and,
scanning the emitted radiation wavelength, said scanning of the emitted radiation wavelength occurring synchronously with the scanning of the coherent radiation source wavelength; and,
wherein the step of analyzing the detected signal further comprises the step of generating a spectrum of emitted radiation; and,
wherein the step of comparing the analysis comprises comparing said generated spectrum to a database of known spectra of potentially hazardous materials.

13. The method of claim 1 wherein said at least one radiation source comprises at least two radiation sources, each one radiation source from the at least two radiation sources being different from any other of said at least two radiation sources.

14. The method of claim 13 wherein said at least two radiation sources are selected from the group consisting of a source of radiation in the visible range of wavelengths, a source of coherent radiation, a continuum light source, a source of X-rays, a source of X-rays for computed tomography, a source of low intensity radio waves for quadrupole resonance, a source of ultrasound radiation, and a source of neutrons; and wherein said interaction between any one radiation source from the at least two radiation sources and said one mail piece is selected from the group consisting of scattering and reflection of said radiation from said one mail piece, transmission of said radiation through said one mail piece, and, absorption of radiation from said one radiation source and generation of emitted radiation; and wherein said at least one detected signal comprises at least two detected signals; and wherein said at least one result comprises at least two results.

15. The method of claim 13 wherein the step of applying an early warning criterion further comprises the steps of:
obtaining a comparison of a first one of said at least two analysis results to first data from a database;
obtaining a subsequent comparison of each subsequent one of said at least two analysis results to second data from a database;
applying data fusion techniques jointly to the comparison of the first one of said at least two analysis results and each subsequent comparison of each subsequent one of said at least two analysis results and obtain an early warning criterion; and,
wherein, said early warning criterion indicates that said one mail piece from the plurality of mail pieces contains potentially hazardous materials and said data fusion techniques are applied in order to decrease incorrect indications.

16. The method of claim 13 wherein the step of applying an early warning criterion further comprises the steps of:
obtaining a comparison of a first one of said at least two analysis results to first data from a database;
obtaining a subsequent comparison of each subsequent one of said at least two analysis results to second data from a database;
applying data fusion techniques jointly to the comparison of the first one of said at least two analysis results and each subsequent comparison of each subsequent one of said at least two analysis results and obtain an early warning criterion; and,
wherein, said comparison said first one of said at least two analysis results indicates that said one mail piece from the plurality of mail pieces contains potentially hazardous materials and said data fusion techniques are applied in order to minimize incorrect indications.

17. The method of claim 1 wherein
the step of exposing one mail piece comprises the step of exposing said one mail piece with at least substantially bright optical radiation source; and,
wherein the step of detecting a signal comprises the step of detecting the signal from a multi-pixel area optical detector arising from receiving a portion of said exposing optical radiation transmitted through said one mail piece.

18. The method of claim 17 wherein said substantially bright optical radiation source comprises a stripe optical radiation source.

19. A system, for the detection of potentially hazardous materials in mail pieces, comprising:
at least one radiation source capable of exposing one mail piece from a plurality of mail pieces;
means for detecting a signal arising from an interaction between said at least one radiation source and said one mail piece from the plurality of mail pieces, said means generating at least one detected signal;
means for transporting each mail piece from the plurality of mail pieces through an illumination area for said at least one radiation source;
means for culling a mail piece from said plurality of mail pieces;
at least one processor;
a first memory for storing data for access by a process executed by at least one processor, said memory comprising a database;
at least one second computer readable memory having instructions embodied therein, said instructions causing said at least one processor to:
analyze said at least one detected signal, said analysis producing at least one result;
compare said at least one analysis result to data from the database;
apply an early warning criterion to said comparison;
if said early warning criterion indicates that said one mail piece from the plurality of mail pieces contains potentially hazardous materials, cause said at least one processor to apply control signal to the culling means.

20. The system of claim 19 wherein said at least one radiation source is selected from the group consisting of a source of radiation in the visible range of wavelengths, a substantially bright optical radiation source, a source of coherent radiation, and a continuum light source a source of X-rays, a source of X-rays for computed tomography, a source of low intensity radio waves for quadrupole resonance, a source of ultrasound radiation, and a source of neutrons.

21. The system of claim 19 wherein said at least one radiation source is selected from the group consisting of a source of radiation in the visible range of wavelengths, a source of coherent radiation; and, said interaction between the radiation source and said one mail piece comprises absorption of the source radiation and generation of emitted radiation; and, the system further comprises means for synchronously scanning in wavelength said source radiation and emitted radiation.

22. The system of claim 19 wherein said at least one radiation source comprises at least two radiation sources, each one radiation source from the at least two radiation sources being different from any other of said at least two radiation sources.

23. The system of claim 19 wherein said at least one radiation source comprises a substantially bright optical radiation source and said interaction between the radiation source and said one mail piece comprises transmitting said optical radiation through said one mail piece.

24. The system of claim 23 wherein said substantially bright optical radiation source comprises a stripe optical radiation source.

25. The system of claim 22 wherein said at least two radiation sources are selected from the group consisting of a source of radiation in the visible range of wavelengths, a substantially bright optical radiation source, a source of coherent radiation, a continuum light source, a source of X-rays, a source of X-rays for computed tomography, a source of low intensity radio waves for quadrupole resonance, a source of ultrasound radiation, and a source of neutrons; and wherein said at least one detected signal comprises at least two detected signals; and wherein said at least one result comprises at least two results.

26. The system of claim 22 wherein instructions causing said at least one processor to apply an early warning criterion to said comparison further cause said at least one processor to:
obtain a comparison of a first one of said at least two analysis results to first data from a database; obtain a subsequent comparison of each subsequent one of said at least two analysis results to second data from a database;
apply detection techniques jointly to the comparison of the first one of said at least two analysis results and each subsequent comparison of each subsequent one of said at least two analysis results and obtain an early warning criterion; and,
wherein, said comparison said first one of said at least two analysis results indicates that said one mail piece from the plurality of mail pieces contains potentially hazardous materials and said detection techniques are applied in order to minimize incorrect indications.

27. A memory for storing data for access by a process executed by a processor, said memory comprising:
a structure for providing data to be compared against results of interaction of at least one radiation source with mail pieces and to be utilized to apply an early warning criterion to said comparison, said structure comprising:
an identifier for said radiation source,
an identifier for said interaction,
an identifier for an analysis form for the result of said interaction,
data for known suspicious interaction results,
an early warning criterion corresponding to said data.

28. The memory of claim 27 wherein said structure further comprises probability data for the occurrence of a correct identification.

29. The memory of claim 27 wherein said at least one radiation source comprises at least two radiation sources and said structure further comprises:
data characterizing said interaction for each said radiation source wherein said characterizing data is utilized as inputs to detection techniques applied in order to minimize incorrect indications.

30. A system, for the detection of potentially hazardous materials in mail pieces, comprising:
at least one sensor capable of providing an indication of a presence of hazardous materials in at least one mail piece;
a mail transport sub-system capable of transporting said at least one mail piece through an operational area of said at least one sensor;
at least one processor receiving and processing data from said at least one sensor;
a culling sub-system capable of culling said at least one mail piece if the presence of hazardous material is detected.

31. A method, for the detection of potentially hazardous materials in mail pieces, comprising the steps of:
providing at least one sensor capable of providing an indication of the presence of potentially hazardous material in at least one mail piece;
sensing the presence of said potentially hazardous material in said at least one mail piece; and,
culling said at least one mail piece, if the presence of said potentially hazardous material is sensed.
